(19) United States
(12) Patent Application Publication
(10) Pub. No.: US 2010/0129054 A1
(43) Pub. Date: May 27, 2010

(54) INFORMATION PROCESSING APPARATUS AND INFORMATION PROCESSING METHOD

(75) Inventor: Akihiko Kobayashi, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/433,656

(22) Filed: Apr. 30, 2009

(30) Foreign Application Priority Data
Nov. 27, 2008 (JP) 2008-302538

(51) Int. Cl. H04N 5/91

(52) U.S. Cl. 386/83; 386/E05.001

(57) ABSTRACT

According to an aspect of the present invention, there is provided an information processing apparatus including: a content information acquisition module configured to acquire first identification information of selected content; a content retrieval module configured to retrieve content having second identification information, the second identification information characterized as being in a same category as the first identification information; and a content display processor configured to perform processing for displaying the first identification information and the second identification information.

### CROSS-REFERENCE TO RELATED APPLICATIONS

This application is based upon and claims the benefit of priority from Japanese Patent Application No. 2008-302538, filed on Nov. 27, 2008, the entire contents of which are incorporated herein by reference.

### BACKGROUND

1. Field

An aspect of the present invention relates to an information processing apparatus and an information processing method.

2. Description of the Related Art

As a related art, there is an information processing apparatus which retrieves program information from an Electronic Program Guide (EPG) based on keyword information and performs recording programming (see JP-A-2006-5541, for instance).

This information processing apparatus has: an EPG acquisition module which acquires an EPG; a keyword input module by which a user inputs desired keyword information; a priority setting module which sets priority for the input keyword information; and a program retrieval module which retrieves program information containing the keyword information from the EPG in accordance with the priority and displays the retrieved program information. Since the user is able to program recording by selecting a desired program from the displayed program information as a result of the retrieval, it is possible to easily program recording in accordance with user's preference.

In the information processing apparatus, it is however necessary for the user to select a program to be recorded when, for example, identical programs matching with the keyword are in the EPG or the like. Accordingly, it is necessary for the user to confirm details of the identical programs in selecting the program.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary schematic view showing the external appearance of an information processing apparatus according to an embodiment of the invention;

FIG. 2 is an exemplary block diagram showing the configuration of the information processing apparatus according to the embodiment of the invention;

FIGS. 3A and 3B are schematic views showing examples of configuration of video display output from the information processing apparatus according to the embodiment of the invention; and

FIG. 4 is a flow chart showing an example of operation of the information processing apparatus according to the embodiment of the invention.

### DETAILED DESCRIPTION

Various embodiments according to the present invention will be described hereinafter with reference to the accompanying drawings. In general, according to one embodiment of the present invention, there is provided an information processing apparatus including: a content information acquisition module configured to acquire first identification information of selected content; a content retrieval module configured to retrieve content having second identification information, the second identification information characterized as being in a same category as the first identification information; and a content display processor configured to perform processing for displaying the first identification information and the second identification information.

An information processing apparatus and an information processing method according to an embodiment of the invention will be described below in detail with reference to the drawings.

(Configuration of Information Processing Apparatus)

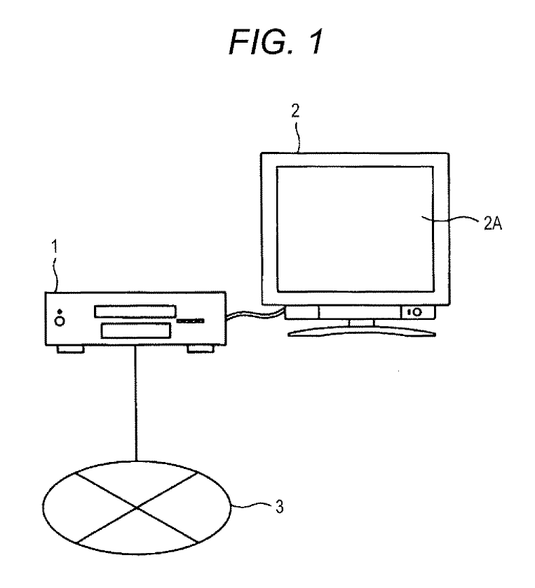

FIG. 1 is a schematic view showing the external appearance of the information processing apparatus according to the embodiment of the invention.

The information processing apparatus 1 is a video recording/reproducing apparatus which is connected to an antenna not shown so as to be able to receive broadcast waves and output video and audio and which is connected to an external network 3 such as the Internet through a Local Area Network (LAN) cable or the like so as to be able to communicate with the outside. The information processing apparatus 1 outputs a video signal and an audio signal to a display device 2 such as an LCD (Liquid Crystal Display) having a display screen 2A. The information processing apparatus 1 has a remote control signal reception module which receives an operation signal transmitted from a remote controller including operating switches based on an operation of any one of the operating switches. The information processing apparatus 1 is operated based on the operation signal.

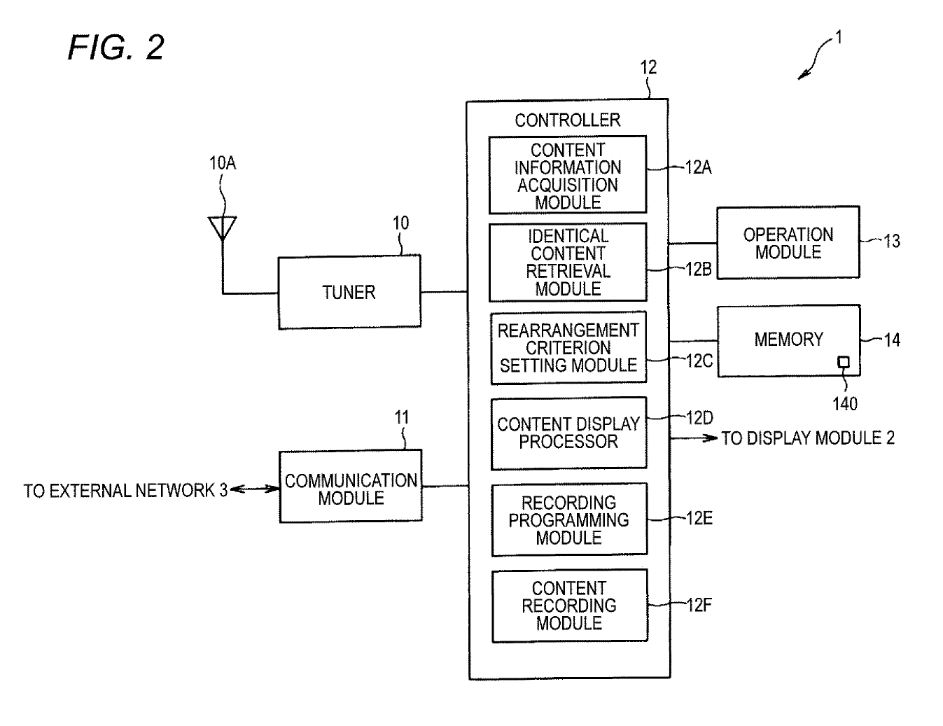

FIG. 2 is a block diagram showing the configuration of the information processing apparatus according to the embodiment of the invention.

The information processing apparatus 1 includes a tuner 10, a communication module 11, a controller 12, an operation module 13, and a memory 14. The tuner 10 receives a transport stream selectively by demodulating while receiving digital broadcast waves or the like from the outside via an antenna 10A. The communication module 11 communicates with a video content distributing server (not shown) through the external network 3. The controller 12 has a video processing function which decodes the transport stream received by the tuner 10 into a video signal and an audio signal and outputs the video signal and the audio signal to the display device 2. The controller 12 has a Central Processing Unit (CPU) which operates a content information acquisition module 12A, an identical content retrieval module 12B, a rearrangement criterion setting module 12C, a recording programming module 12E and a content recording module 12F. The operation module 13 serves as an operation device including a remote controller, and a remote control signal reception module. The memory 14 includes a Hard Disk Drive (HDD) which stores information including video contents.

The content information acquisition module 12A is a module which acquires associated information on a video content selected by a user. The identical content retrieval module 12B is a module which extracts identification information from the acquired associated information and retrieves contents characterized as being in the same category as the video content selected by the user. The rearrangement criterion setting module 12C is a module which sets a criterion for rearrangement of the identical contents based on a user's operation. The content display processor 12D is a module which performs processing to display the video content selected by the user and the identical contents. The recording programming module 12E is a module which performs recording programming of a video content selected from the video contents displayed by the content display processor 12D. The content recording module 12F is a module which records the video content programmed by the recording programming module 12E and stores the recorded video content into the memory 14.

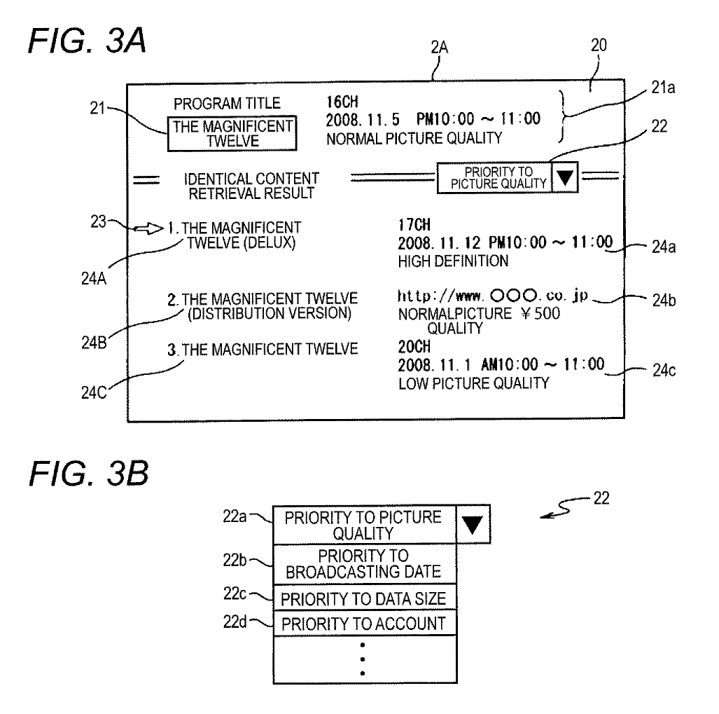

FIGS. 3A and 3B are schematic views showing examples of configuration of video display output from the information processing apparatus according to the embodiment of the invention.

As shown in FIG. 3A, an identical content display screen 20 is displayed on the display screen 2A. The identical content display screen 20 contains a target content 21, a criterion selection module 22, a cursor 23, and identical contents 24A to 24C. The target content 21 indicates a video content selected from an EPG or the like by the user. The criterion selection module 22 is for selecting a criterion for determining display priority of contents identical to the target content 21. The cursor 23 is for selecting a video content to be programmed. The identical contents 24A to 24C have identical content to the target content 21. The identical contents 24A to 24C have the same title as the target content 21 and different version from that of the target content 21. The different version indicates different bit rate or resolution, for example.

The identical contents 24A to 24C have detailed information 24a to 24c indicating details of associated information, respectively. Each of the detailed information 24a to 24c has channel or distribution source address information, broadcasting day and time information, picture quality information, accounting information, etc.

When the cursor 23 is moved to operate the criterion selection module 22, as shown in FIG. 3B, a pull-down menu is displayed. The pull-down menu contains criteria 22a to 22d. The criterion 22a is “Priority to Picture Quality” which is an item for rearranging the identical video contents in descending order of resolution or bit rate. The criterion 22b is “Priority to Broadcasting Date” which is an item for rearranging the identical video contents in order of broadcasting day and time. The criterion 22c is “Priority to Data Size” which is an item for rearranging the identical video contents in ascending order of data size. The criterion 22d is “Priority to Account” which is an item for rearranging the identical video contents in ascending order of video charge.

(Operation)

Operation of the information processing apparatus in the embodiment of the invention will be described below with reference to the respective drawings.

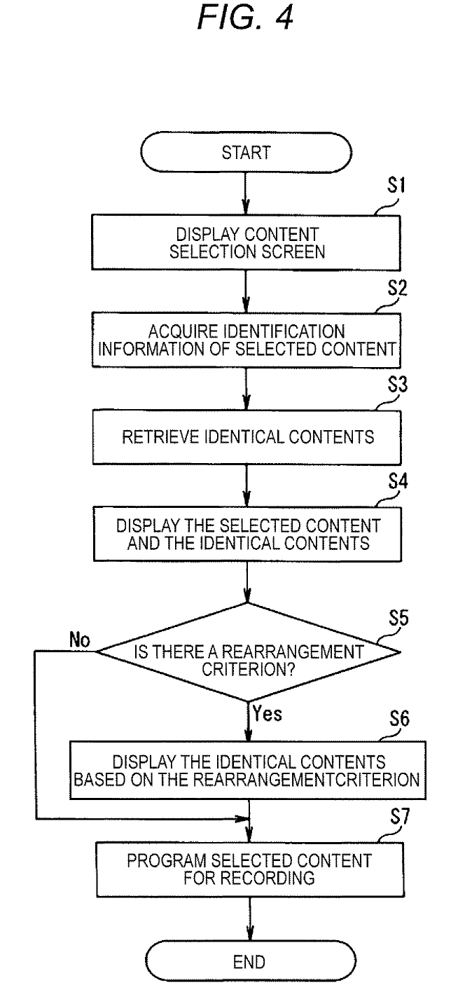

FIG. 4 is a flow chart showing an example of the operation of the information processing apparatus according to the embodiment of the invention.

First, when the user operates the remote controller or the like to display an EPG, the controller 12 of the information processing apparatus 1 controls the display device 2 to display a program list in the EPG form as a content selection screen on the display screen 2A (S1). When the user selects a desired video content on the content selection screen, the content information acquisition module 12A acquires associated information on the video content selected by the user, and acquires identification information such as title, identification number, etc. of the video content from the associated information (S2).

Then, the identical content retrieval module 12B retrieves identical contents from an external video content distributing server, the EPG, etc. based on the acquired identification information of the video content (S3). As shown in FIG. 3A, the identical contents as a result of the retrieval and the video content selected by the user are displayed as the identical contents 24A to 24C and the target content 21, respectively, by the controller 12 (S4). The criterion selection module 22 is displayed, as shown in FIGS. 3A and 3B, by the rearrangement criterion setting module 12C.

Then, when any one of the criteria 22a to 22d in the criterion selection module 22 is selected by the user (Yes in S5), the content display processor 12D compares the detailed information 24a to 24c as associated information on the identical contents 24A to 24C with one another based on the rearrangement criterion, rearranges the identical contents 24A to 24C and displays the rearranged identical contents 24A to 24C (S6). When, for example, the rearrangement criterion is

“Priority to Data Size”, the identical content 24C which is a video content with low picture quality, the identical content 24B with normal picture quality and the identical content 24A with high definition are rearranged and displayed in this order. On the other hand, when the rearrangement criterion is not selected (No in S5), the routine of processing goes to step 57.

Then, the recording programming module 12E programs recording of a video content selected by the user from the target content 21 and the identical contents 24A to 24C displayed on the identical content display screen 20 (S7). When the selected video content is content such as the identical content 24B which needs to be downloaded from the video content distributing server, downloading is performed.

When it comes to the recording time after the aforementioned operation, the content recording module 12F executes the recording and stores the recorded video content in the memory 14.

(Effect of Embodiment)

According to the aforementioned embodiment, the identical contents 24A to 24C which have video contents identical to the target content 21 that is a video content selected by the user are retrieved and displayed, so that the user is able to view a desired video content in a desired criterion. By changing the criterion from one of the criteria 22a to 22d to another, the identical contents 24A to 24C are able to be compared with one another easily.

Configuration may be made so that the controller 12 automatically selects a video content to be programmed based on one of the criteria 22a to 22d without user's selection of the video content to be programmed. Or configuration may be made so that one of the criteria 22a to 22d is set in advance. Or scenes identical to one scene such as a music clip contained in a video content may be retrieved and displayed as identical scenes.

What is claimed is:

1. An information processing apparatus comprising:
a content information acquisition module configured to acquire first identification information of selected content;
a content retrieval module configured to retrieve content having second identification information, the second identification information characterized as being in a same category as the first identification information; and
a content display processor configured to perform processing for displaying the first identification information and the second identification information.

2. An information processing apparatus comprising:
a content information acquisition module configured to acquire first identification information of selected content;
a content retrieval module configured to retrieve a plurality of pieces of contents, each having second identification information, the second identification information characterized as being in a same category as the first identification information;
a criterion setting module configured to set a criterion for displaying retrieved contents; and
a content display processor configured to:
perform processing for displaying the first identification information; and
perform processing for displaying a plurality of pieces of the second identification information rearranged based on first associated information according to the criterion associated with each of the plurality of pieces of contents.

3. The information processing apparatus of claim 2, further comprising a recording programming module configured to:
specify a content based on the criterion, the first associated information and second associated information associated with the selected content; and
program the specified content for recording.

4. The information processing apparatus of claim 1, wherein the content display processor is configured to perform processing for displaying associated information associated with the selected content and the content retrieved by the content retrieval module.

5. The information processing apparatus of claim 2, wherein the content display processor is configured to perform processing for displaying the first associated information and second associated information associated with the selected content.

6. An information processing method comprising:
acquiring first identification information of selected content;
retrieving content having second identification information, the second identification information characterized as being in a same category as the first identification information; and
performing processing for displaying the first identification information and the second identification information.
